(19) United States
(12) Patent Application Publication
(10) Pub. No.: US 2025/0380807 A1
(43) Pub. Date: Dec. 18, 2025

(54) INJECTION MOLDED STRUCTURAL SUBSTRATES FOR SOFT SEATING

(71) Applicant: Medway Plastics Corporation, Pflugerville, TX (US)

(72) Inventors: Thomas A. Hutchinson, Pflugerville, TX (US); Richard E. Hutchinson, Pflugerville, TX (US)

(21) Appl. No.: 19/219,320

(22) Filed: May 27, 2025

Related U.S. Application Data
(60) Provisional application No. 63/651,788, filed on May 24, 2024.

(51) Int. Cl. A47C 5/12; B29C 44/02; B29K 23/00; B29K 105/04; B29L 31/44

(52) U.S. Cl. CPC A47C 5/125; B29C 44/02; B29K 2023/12; B29K 2105/04; B29L 2031/443

(57) ABSTRACT

An article and a method of manufacturing soft seating comprises a rigid, injection-molded thermoplastic substrate are disclosed. The soft seat article comprises an injection molded structural substrate element that may be over-molded with soft open cell polyurethane or other open or closed cell foam materials to create a soft chair. The soft foam outer surface may be upholstered with fabric or other traditional materials to finish the soft chair. The method of manufacturing comprises molding an inner structural shell from thermoplastic materials, encapsulating the inner structural shell in a soft foam material, optionally upholstering the outer surface of the soft foam material, and optionally providing a base.

### CROSS-REFERENCE TO RELATED APPLICATIONS

This application claims the benefit of U.S. Patent Application Ser. No. 63/651,788 filed May 24, 2024, the disclosure of which is incorporated herein by reference in it entirety.

### BACKGROUND

### Field of the Invention

This disclosure is in the field of manufacturing seating. More specifically, this disclosure is in the field of manufacturing soft seating utilizing a structural substrate encapsulated in a soft seating material.

### Description of the Related Art

The processes and methods currently used to manufacture soft seating require a structural substrate to be formed of glass fiber cloth that is hand laid into a mold and then encapsulated by a liquid that undergoes a chemical reaction to form a rigid foam element. This encapsulated fiber cloth comprises a “structural substrate”. The structural substrate is then encapsulated with a soft material such as open cell urethane foam to form the final soft seat. The fabrication processes, especially for the structural substrate, require time-consuming and labor-intensive manual procedures. A more automated and less labor-intensive process that results in a more uniform final product is desirable.

### SUMMARY OF THE INVENTION

In varying embodiments of the current invention and in products arising therefrom, the structural substrate is made from injection molded thermoplastic resin. In some embodiments, the chair may have a steel rod or tube support structure. In other embodiments the chair may have a nylon or metal base support structure.

In various embodiments, the inventive chair comprises an injection-molded thermoplastic structural substrate, and an outer foam layer molded over all or part of the structural substrate. In some embodiments, the structural substrate is a foamed thermoplastic material. In some embodiments, the structural substrate comprises an integral skin foam. In some embodiments, the outer foam layer is a soft foam. In some embodiments, the injection-molded structural substrate is a material comprising thermoplastic microcell foam spheres. In some embodiments, the injection-molded structural substrate is injection-molded utilizing post-consumer or post-industrial recycled materials.

In some embodiments, the injection-molded structural substrate is encapsulated in organic or synthetic foam. In other embodiments, the structural substrate is covered with pieces of foam. In some embodiments, the injection-molded structural substrate is reinforced with glass fiber material. In other embodiments, the injection-molded structural substrate is reinforced with carbon fiber material.

In some embodiments, the structural substrate is molded from a thermoplastic resin comprising polypropylene containing 0% to 50% glass fiber, and 0% to 25% heat activated foam blend. In other embodiments, the structural substrate is molded from a thermoplastic resin comprising 0% to 50% glass fiber and a thermoplastic material selected from the group consisting of polyamide, polyethylene, polyhydroxybutyrate, and polyethylene terephthalate.

In some embodiments, the invention comprises a process for manufacturing a chair comprising the steps of injecting a thermoplastic resin and a chemical foaming agent into a mold to form a structural substrate and molding an outer foam layer over the structural substrate. In some embodiments of the process, the thermoplastic resin comprises polypropylene containing 0% to 50% glass fiber, and 0% to 25% heat activated foam blend. In other embodiments of the process, the thermoplastic resin comprises 0% to 50% glass fiber and a thermoplastic material selected from the group consisting of polyamide, polyethylene, polyhydroxybutyrate, and polyethylene terephthalate.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

A preferred embodiment of the invention, illustrative of the best mode in which the applicant has contemplated applying the principles, is set forth in the following description and is shown in the drawings and is particularly and distinctly pointed out and set forth in the appended claims.

FIG. 1 is a perspective view of an injection-molded structural substrate of an embodiment of the inventive seat assembly.

FIG. 2 is a perspective view of various components of embodiments of the inventive seat assembly.

FIG. 3 is a perspective view of an embodiment of the inventive seat assembly.

FIG. 4 is a bottom view of an embodiment of the inventive seat assembly.

FIG. 5 is a bottom view of an embodiment of the structural substrate of an inventive seat assembly.

FIG. 6 is a front perspective view of an embodiment of the inventive seat assembly with an attached base component.

FIG. 7 is a lower perspective view of an embodiment of the inventive seat assembly with an attached base component.

FIG. 8 is a perspective view of a portion of an embodiment of the inventive seat assembly.

FIG. 9 is a bottom view of the embodiment of FIG. 8.

FIG. 10 is a perspective view of the embodiment of FIG. 8 with the seat pan component removed.

FIG. 11 is a perspective view of the seat pan component of the embodiment of FIG. 8.

FIG. 12 is an exploded view of the embodiment of FIG. 8.

### DETAILED DESCRIPTION

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

In varying embodiments of the current invention and in products arising therefrom, the structural substrate is made from injection molded thermoplastic resin thus eliminating the manual process of hand fabricating the structural substrate from glass fiber cloth. Various embodiments of the inventive processes and methods reduce manufacturing time, allow the use of renewable and or recycle materials, improve dimensional accuracy, improve structural integrity, and/or reduce cost.

An article and a method of manufacturing soft seating comprises a rigid, injection-molded thermoplastic substrate. The soft seat article, in varying embodiments, may comprise an injection molded structural substrate element that may be over-molded or covered with soft open cell polyurethane or other open or closed cell foam materials to create a soft chair. The soft foam outer surface in some embodiments is upholstered with fabric or other traditional materials to finish the soft chair. In some embodiments the structural substrate provides shape and/or mechanical support to the soft outer layer. In some embodiments the structural substrate determines the shape of the chair.

The elimination of the hand-crafted structural substrate significantly accelerates the manufacturing time while adding automation, dimensional accuracy, structural strength and the application of both post-consumer and post-industrial materials.

In some embodiments, the chair is supported by means of a steel wire frame, traditional nylon base or a combination thereof. In some embodiments of the inventive chair, the injection molded substrate with over-molded foam is suited for automotive seats and racing or high-performance applications that require strength and impact resistance. In some embodiments the inventive chair is a structural weight bearing seat.

In some embodiments the structural substrate is a foamed thermoplastic material made by structural foam molding. In some embodiments, the structural substrate is formed by injection-molding thermoplastic with foaming agents added to the plastic resin. In some embodiments the foaming agents are chemical foaming agents. In some embodiments the foaming agents are physical foaming agents. Some of these embodiments allow for injection molding with reduced clamp tonnage for large surface area rigid plastic substrates, resulting in lower tooling costs. Some of these embodiments also allow for structural substrates with less weight.

In some embodiments the structural substrate is foamed thermoplastic material with a solid outer skin. In some of these embodiments with a solid outer skin, the structural substrate has an internal core with a cellular or foamed structure. Some of these embodiments are integral skin foam materials.

The use of injection molding technologies provides for dimensional stability and repeatable manufacturing to tight tolerances. This results in a more consistent manufacturing process. A more consistent structural substrate allows use of the structural substrate with tight tolerance applications such as automotive applications. It also allows the use of the structural substrate with metal support legs or other manufactured components that need accurate dimension for proper mating and attachment together. Various embodiments utilize wire frame support legs, tubular frame elements, a gas cylinder style base, or other types and styles of thermoplastic or metal bases.

In various embodiments, the rigid structural substrate is formed from any thermoplastic material, filled or unfilled. In various embodiments of the inventive chair, from 0% to 60% of the injection material comprises glass or carbon fiber, chemical foaming agents, microcells, and other similar additives for thermoplastic injection molding. In some embodiments the structural substrate incorporates recycled material, such as post-consumer content or post-industrial content, or renewable thermoplastic materials.

In some embodiments of the inventive substrate, the thermoplastic material for injection molding is (i) polypropylene containing 0% to 50% glass fiber, (ii) polypropylene containing 0% to 25% heat activated foam blend, (iii) polyamide with 0% to 50% glass fiber, (iv) polyethylene with 0% to 50% glass fiber, (v) polylactic acid (PLA) with 0% to 50% glass fiber, (vi) polyhydroxybutyrate (PHB) with 0% to 50% glass fiber, or (vi) polyethylene terephthalate (PET) with 0% to 50% glass fiber.

Some embodiments of the inventive chair have a soft outer layer over all or part of the structural substrate. In some embodiments of the inventive chair a soft outer layer is made from polyurethane elastomeric material. In some embodiments the soft outer layer is over-molded on the structural substrate. In some embodiments the soft outer layer is adhered to the structural substrate.

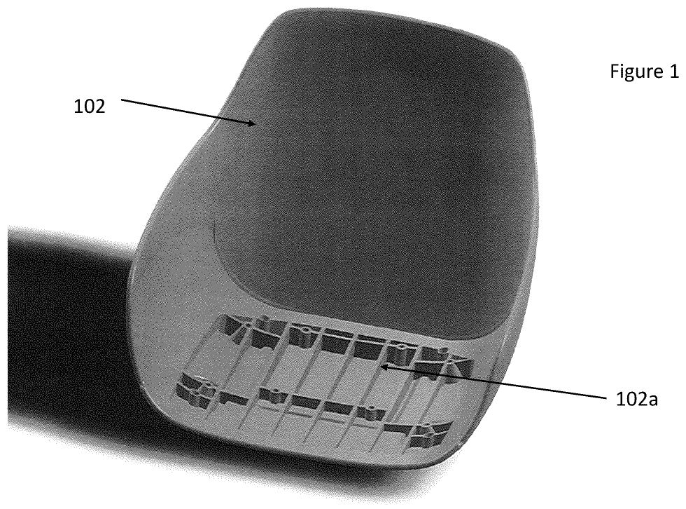

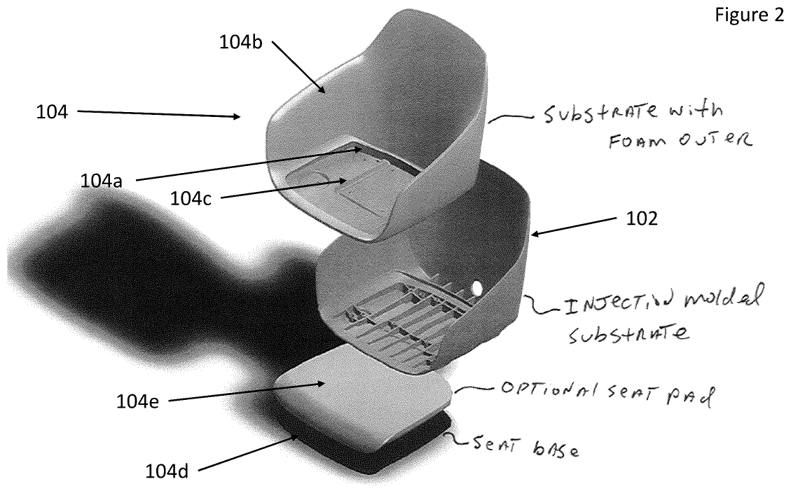

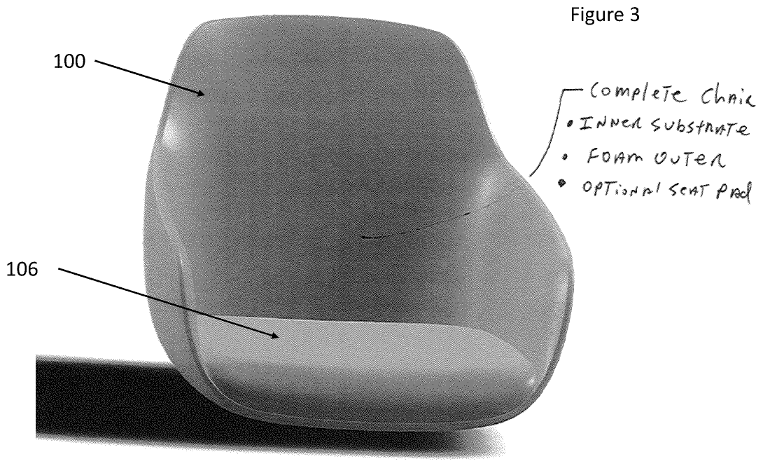

Referring now to FIGS. 1, 2, and 3, perspective views of components and completed assemblies of several embodiments of the inventive chair or seat assembly 100 are depicted. The embodiment of injection molded structural substrate 102 is depicted after molding but before encapsulation in an outer foam layer. The embodiment of substrate 102 is depicted with ribs 102a in the seat area for additional strength. The embodiment of covered substrate 104 comprises an injection-molded structural substrate 104a with an encapsulating foam layer 104b. In this embodiment the outer foam layer 104b is not applied to the seat area 104c which will receive a seat base 104d and optionally a seat pad 104e. In some embodiments, the seat base 104d is injection-molded plastic component. In varying embodiments, the seat base 104d is used for attachment of seat pad 104e or as a non-upholstered smooth seat. The embodiment of covered substrate 104a does not have ribs in seat area 104c. In some embodiments the ribs in seat area 104c are removed to provide a smooth, non-upholstered seat. FIG. 3 depicts an embodiment of the inventive seat assembly in fully assembled form. The seat 100 comprises an injection-molded structural substrate and an upholstered pad 106 is provided.

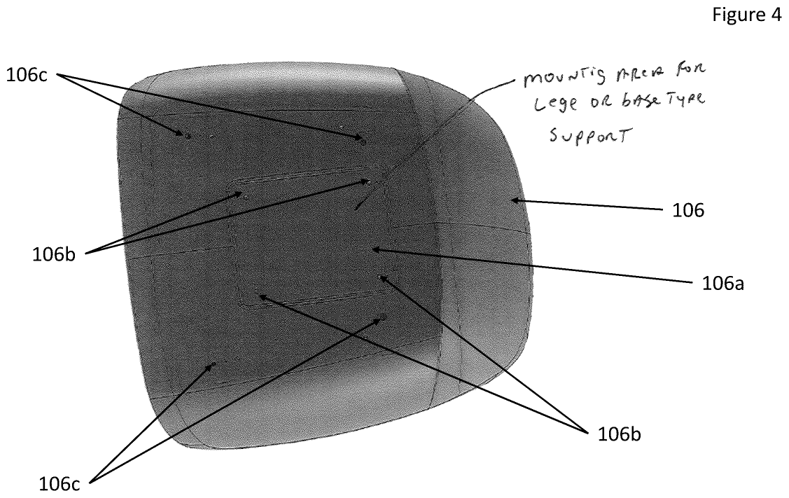

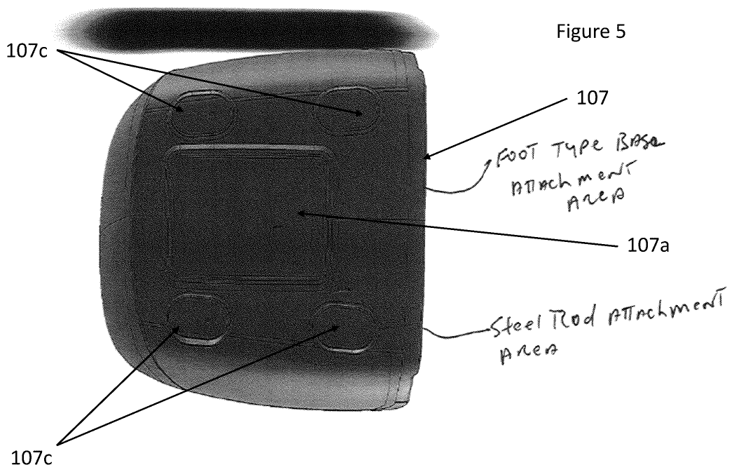

FIGS. 4 and 5 depict bottom views of an embodiment of the structural substrate with an over-molded foam layer in FIG. 4, and without the over-molded foam layer in FIG. 5. In FIG. 4, the bottom of seat 106 is provided with a seat mounting area 106a. In some embodiments the mounting area 106a is inset to receive a base plate for a chair stand or in some embodiments is thickened or internally reinforced to provide additional support to the seat 106 when mounted on a base. In some embodiments the mounting area 106a is provided with one or more mounting holes 106b for receiving fasteners to attach a base plate of the chair stand or legs to the seat 106. In some embodiments additional holes 106c are provided for receiving steel support rods or legs as depicted in a later figure. FIG. 5 depicts the bottom of an embodiment of the injection-molded structural substrate 107 with structures to provide extra support for the legs or base or extra material for forming holes or sockets for receiving the legs or fasteners for the base or legs. In the depicted embodiment the support areas include base attachment area 107a for a foot type chair stand or base, and attachment areas 107c for supporting and attaching steel rod legs.

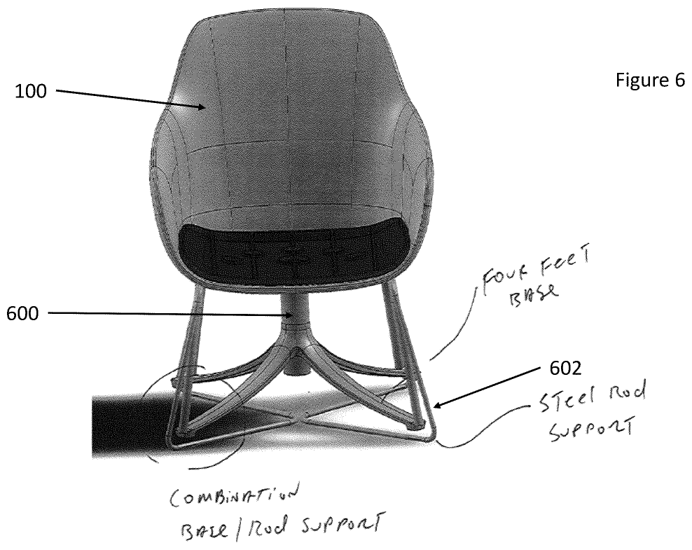

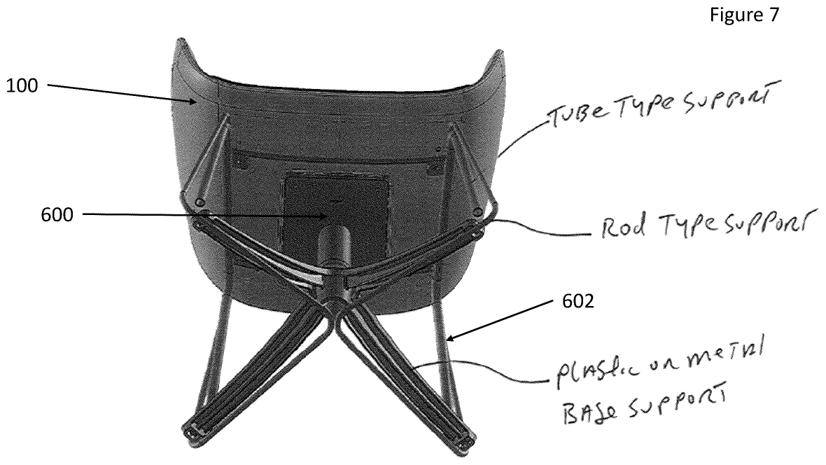

FIGS. 6 and 7 depict views of an embodiment of the inventive chair with base and support rod attachments. In these depictions the embodiment of the chair 100 is supported by a stand-style base 600 and steel support rods or legs 602. Other styles of stands, legs, or support rods are used with various embodiments of the inventive chair.

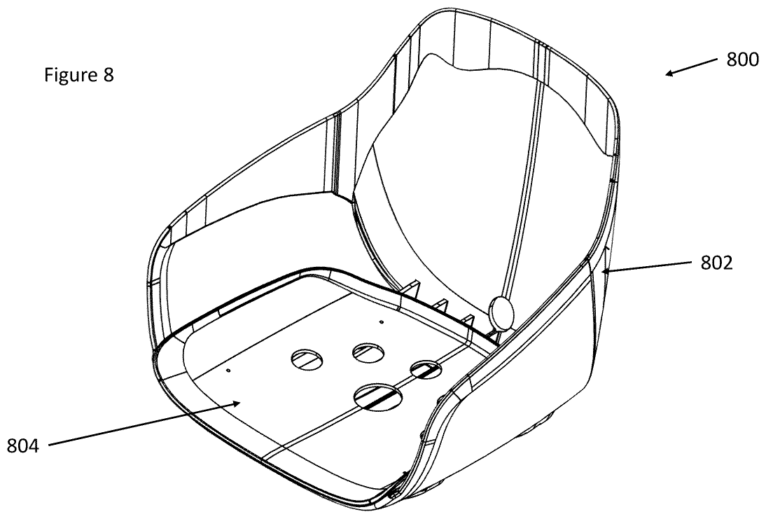

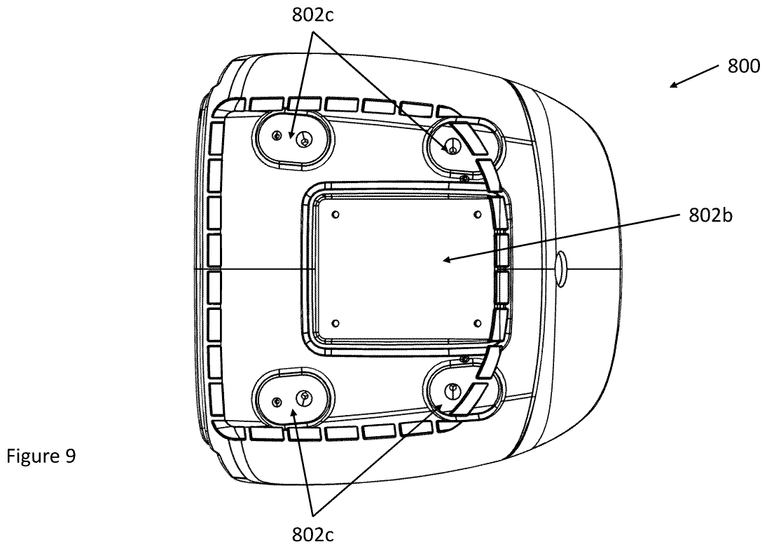

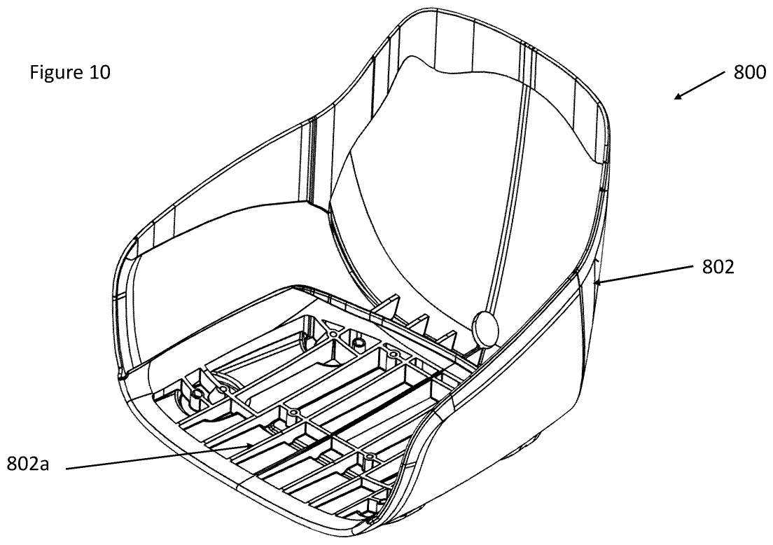

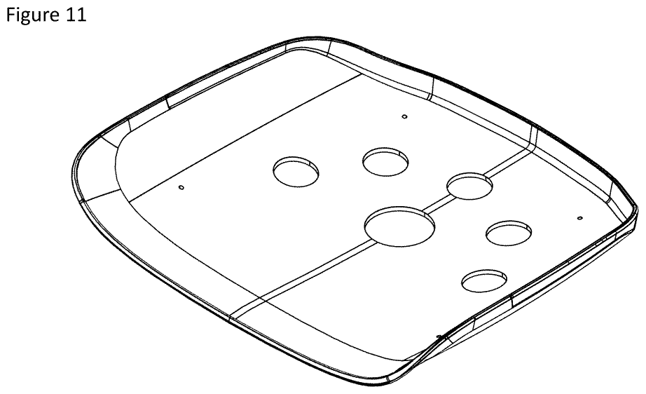

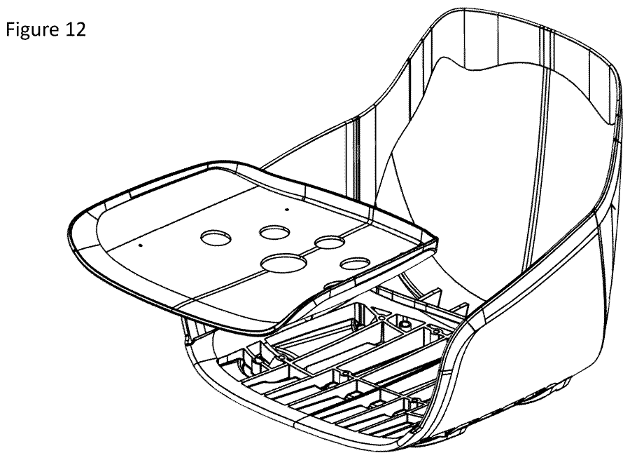

FIGS. 8 through 12 depict an embodiment of the structural substrate with an optional seat pan. In this depiction of the inventive chair, the outer layer of soft foam has not yet been molded or attached to the substrate 800. This embodiment of the inventive chair is provided with an optional seat pan 804 that may be attached over the ribs 802a in the seat area of the chair 800. The bottom surface of the substrate 800 is depicted in FIG. 9 with an area 802b for attaching a mounting plate of a base or stand for the chair 100. This embodiment is also depicted with areas 802c for attaching or receiving a legs or rods for stabilizing or supporting the chair 100. In varying embodiments, a stand and legs may be used together as depicted in FIGS. 6 and 7, or separately, to support the chair at a desired height.

The following item lists A, B, C, etc. are illustrative, but not limiting, of embodiments of the inventive device. Features of the following item lists may constitute features of the other item lists. The reference numbers provided in the item descriptions are for ease of reference to the figures and shall not be construed as limiting their subject matter.

A1. An inventive soft seat chair comprising an injection-molded structural substrate encapsulated in a soft outer material.

A2. The inventive soft seat chair according to A1, wherein the injection-molded structural substrate is an injection-molded thermoplastic material.

A3. The inventive soft seat chair according to any of the preceding A items, wherein the injection-molded structural substrate is a material comprising thermoplastic microcell foam spheres.

A4. The inventive soft seat chair according to any of the preceding A items, wherein the injection-molded structural substrate is injection-molded utilizing post-consumer or post-industrial recycled materials.

A5. The inventive soft seat chair according to any of the preceding A items, wherein the injection-molded structural substrate is injection-molded utilizing renewable materials.

A6. The inventive soft seat chair according to any of the preceding A items, wherein the injection-molded structural substrate is a material suitable for stapling or attaching fabric or other upholstery materials.

A7. The inventive soft seat chair according to any of the preceding A items, wherein the injection-molded structural substrate is encapsulated in organic or synthetic foam.

A8. The inventive soft seat chair according to any of the preceding A items, wherein the structural substrate is covered with pieces of foam.

A9. The inventive soft seat chair according to any of the preceding A items, wherein the injection-molded structural substrate is reinforced with glass fiber material.

A10. The inventive soft seat chair according to any of the preceding A items, wherein the injection-molded structural substrate is reinforced with carbon fiber material.

A11. The inventive soft seat chair according to any of the preceding A items, wherein the soft outer material is upholstered.

B1. An inventive chair comprising an injection-molded thermoplastic structural substrate, an outer foam layer molded over all or part of the structural substrate.

B2. The inventive chair according to B1, wherein the structural substrate is a foamed thermoplastic material.

B3. The inventive chair according to any of the preceding B items, wherein the structural substrate comprises an integral skin foam.

B4. The inventive chair according to any of the preceding B items, wherein the outer foam layer is a soft foam.

B5. The inventive chair according to any of the preceding B items, wherein the injection-molded structural substrate is a material comprising thermoplastic microcell foam spheres.

B6. The inventive chair according to any of the preceding B items, wherein the injection-molded structural substrate is injection-molded utilizing post-consumer or post-industrial recycled materials.

B7. The inventive chair according to any of the preceding B items, wherein the injection-molded structural substrate is encapsulated in organic or synthetic foam.

B8. The inventive chair according to any of the preceding B items, wherein the structural substrate is covered with pieces of foam.

B9. The inventive chair according to any of the preceding B items, wherein the injection-molded structural substrate is reinforced with glass fiber material.

B10. The inventive chair according to any of the preceding B items, wherein the injection-molded structural substrate is reinforced with carbon fiber material.

B11. The inventive chair according to any of the preceding B items, wherein the structural substrate is molded from a thermoplastic resin comprising polypropylene containing 0% to 50% glass fiber, and 0% to 25% heat activated foam blend.

B12. The inventive chair according to any of the preceding B items wherein the structural substrate is molded from a thermoplastic resin comprising 0% to 50% glass fiber and a thermoplastic material selected from the group consisting of polyamide, polyethylene, polyhydroxybutyrate, and polyethylene terephthalate.

C1. An inventive process for manufacturing a chair, the process comprising the steps of injecting a thermoplastic resin and a chemical foaming agent into a mold to form a structural substrate, and molding an outer foam layer over the structural substrate.

C2. The inventive process according to C1, wherein the thermoplastic resin comprises polypropylene containing 0% to 50% glass fiber, and 0% to 25% heat activated foam blend.

C3. The inventive process according to any of the preceding C items, wherein the thermoplastic resin comprises 0% to 50% glass fiber and a thermoplastic material selected from the group consisting of polyamide, polyethylene, polyhydroxybutyrate, and polyethylene terephthalate.

C4. The inventive process according to any of the preceding C items, wherein the injection-molded structural substrate comprises thermoplastic microcell foam spheres.

D1. An inventive chair comprising a rigid thermoplastic structural substrate formed by injection-molding encapsulated in a foam outer layer.

D2. The inventive chair according to claim D1, wherein the substrate comprises a polymeric substrate having a solid outer skin and an internal core having a cellular structure.

D3. The inventive chair according to any of the preceding D items, wherein the substrate provides shape and mechanical and structural support for a chair seat, and the foam outer layer is a soft material.

D4. The inventive chair according to any of the preceding D items, wherein the foam outer layer is a polyurethane material.

D5. The inventive chair according to any of the preceding D items, wherein the substrate is molded from a thermoplastic resin comprising 0% to 60% glass or carbon fiber.

D6. The inventive chair according to any of the preceding D items, wherein the substrate is molded from a thermoplastic resin comprising 0% to 15% glass or carbon fiber.

D7. The inventive chair according to any of the preceding D items, wherein the substrate is molded from a thermoplastic resin comprising 15% to 30% glass or carbon fiber.

D8. The inventive chair according to any of the preceding D items, wherein the substrate is molded from a thermoplastic resin comprising 30% to 45% glass or carbon fiber.

D9. The inventive chair according to any of the preceding D items, wherein the substrate is molded from a thermoplastic resin comprising 45% to 60% glass or carbon fiber.

D10. The inventive chair according to any of the preceding D items, wherein the substrate is molded from a thermoplastic resin comprising chemical foaming agents.

D11. The inventive chair according to any of the preceding D items, wherein the substrate is molded from a thermoplastic resin comprising microcell materials.

D12. The inventive chair according to any of the preceding D items, wherein the substrate is molded from a polypropylene material comprising 0% to 50% glass fiber.

D13. The inventive chair according to any of the preceding D items, wherein the substrate is molded from a polypropylene material comprising 0% to 25% heat activated foaming agents.

D14. The inventive chair according to any of the preceding D items, wherein the substrate is molded from a polyamide material comprising 0% to 50% glass fiber.

D15. The inventive chair according to any of the preceding D items, wherein the substrate is molded from a polyethylene material comprising 0% to 50% glass fiber.

D17. The inventive chair according to any of the preceding D items, wherein the substrate is molded from a PLA material comprising 0% to 50% glass fiber.

D18. The inventive chair according to any of the preceding D items, wherein the substrate is molded from a PHB material comprising 0% to 50% glass or carbon fiber.

D19. The inventive chair according to any of the preceding D items, wherein the substrate is molded from a PET material comprising 0% to 50% glass or carbon fiber.

“Substantially”, “approximately”, or “about” means to be more-or-less conforming to the particular dimension, range, shape, concept, or other aspect modified by the term, such that a feature or component need not conform exactly. For example, a “substantially cylindrical” object means that the object resembles a cylinder but may have one or more deviations from a true cylinder. The terms “about” or “substantially” or “approximately” as used herein indicates the value of a given quantity that can vary based on a particular technology. Based on the particular technology, the term “about” or “substantially” or “approximately” can indicate a value of a given quantity that varies within, for example, 1-15% of the value (e.g., ±1%, ±2%, ±5%, ±10%, or ±15% of the value).

“Comprising,” “including,” and “having” (and conjugations thereof) are used interchangeably to mean including but not necessarily limited to, and are open-ended terms not intended to exclude additional, unrecited elements or method steps.

Changes may be made in the above methods, devices and structures without departing from the scope hereof. Many different arrangements of the various components depicted, as well as components not shown, are possible without departing from the spirit and scope of the present invention. Embodiments of the present invention have been described with the intent to be illustrative and exemplary of the invention, rather than restrictive or limiting of the scope thereof. Alternative embodiments will become apparent to those skilled in the art that do not depart from its scope. Specific structural and functional details disclosed herein are not to be interpreted as limiting, but merely as a representative basis for teaching one of skill in the art to employ the present invention in any appropriately detailed structure. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

Aspects of the present disclosure are described in detail with reference to aspects thereof as illustrated in the accompanying drawings. References to “one aspect,” “an aspect,” “some aspects,” “an embodiment,” “varying embodiments,” etc., indicate that the aspect(s) described may include a particular feature, structure, or characteristic, but every aspect or embodiment may not necessarily include the particular feature, structure, or characteristic. Moreover, such phrases are not necessarily referring to the same aspect. Further, when a particular feature, structure, or characteristic is described in connection with an aspect, it is submitted that it is within the knowledge of one skilled in the art to affect such feature, structure, or characteristic in connection with other aspects whether or not explicitly described.

Spatially relative terms, such as “beneath,” “below,” “lower,” “above,” “on,” “upper,” “opposite” and the like, may be used herein for ease of description to describe one element or feature's relationship to another element(s) or feature(s) as illustrated in the figures. The spatially relative terms are intended to encompass different orientations of the device in use or in operation in addition to the orientation depicted in the figures. The apparatus may be otherwise oriented (e.g., rotated 90 degrees or at other orientations) and the spatially relative descriptors used herein may likewise be interpreted accordingly.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall with in the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

1. A chair comprising:
an injection-molded thermoplastic structural substrate;
an outer foam layer molded over all or part of the structural substrate.

2. The chair of claim 1, wherein the structural substrate is a foamed thermoplastic material.

3. The chair of claim 1, wherein the structural substrate comprises an integral skin foam.

4. The chair of claim 1, wherein the outer foam layer is a soft foam.

5. The chair of claim 1, wherein the injection-molded structural substrate is a material comprising thermoplastic microcell foam spheres.

6. The chair of claim 1, wherein the injection-molded structural substrate is injection-molded utilizing post-consumer or post-industrial recycled materials.

7. The chair of claim 4, wherein the injection-molded structural substrate is encapsulated in organic or synthetic foam.

8. The chair of claim 1, wherein the structural substrate is covered with pieces of foam.

9. The chair of claim 1, wherein the injection-molded structural substrate is reinforced with glass fiber material.

10. The chair of claim 1, wherein the injection-molded structural substrate is reinforced with carbon fiber material.

11. The chair of claim 1, wherein the structural substrate is molded from a thermoplastic resin comprising polypropylene containing 0% to 50% glass fiber, and 0% to 25% heat activated foam blend.

12. The chair of claim 1, wherein the structural substrate is molded from a thermoplastic resin comprising 0% to 50% glass fiber and a thermoplastic material selected from the group consisting of polyamide, polyethylene, polyhydroxybutyrate, and polyethylene terephthalate.

13. A process for manufacturing a chair comprising the steps of:
injecting a thermoplastic resin and a chemical foaming agent into a mold to form a structural substrate;
molding an outer foam layer over the structural substrate.

14. The process of claim 13 wherein the thermoplastic resin comprises polypropylene containing 0% to 50% glass fiber, and 0% to 25% heat activated foam blend.

15. The process of claim 13 wherein the thermoplastic resin comprises 0% to 50% glass fiber and a thermoplastic material selected from the group consisting of polyamide, polyethylene, polyhydroxybutyrate, and polyethylene terephthalate.

16. The process of claim 13 wherein the injection-molded structural substrate comprises thermoplastic microcell foam spheres.
